(19) United States
(12) Patent Application Publication
(10) Pub. No.: US 2026/0214571 A1
(43) Pub. Date: Jul. 23, 2026

(54) METHODS, ARCHITECTURES, APPARATUSES AND SYSTEMS FOR MULTI-AP NEGOTIATED TARGET WAKE TIME OPERATION

(71) Applicant: InterDigital Patent Holdings, Inc., Wilmington, DE (US)

(72) Inventors: Zinan LIN, Basking Ridge, NJ (US); Hanqing LOU, Syosset, NY (US)

(21) Appl. No.: 19/157,857

(22) PCT Filed: Feb. 26, 2024
(86) PCT No.: PCT/US2024/017308

§ 371 Date: Aug. 19, 2025

Related U.S. Application Data
(60) Provisional application No. 63/447,795, filed on Feb. 23, 2023.

(51) Int. Cl. H04W 52/02

(52) U.S. Cl. CPC H04W 52/0216; H04W 52/0219

(57) ABSTRACT

Multiple Access Points (APs) may operate within a same Coordinated Multi-AP (C-MAP) set, and may have overlapping service areas and overlapping Target Wake Time (TWT) Service Periods (SPs), where TWT allows an AP to negotiate a wake-up period during which a station (STA) and an AP may transmit and receive, and be in power save mode otherwise. To minimize access contention to the wireless radio medium between STAs and APs and maximize availability of STAs and APs, especially in environments where Ultra-High Reliability (UHR) comes into play, a mechanism enabling to support negotiation of TWT operational parameters between APs in C-MAP is disclosed.

### CROSS-REFERENCE TO RELATED APPLICATIONS

This application claims the benefit of U.S. Provisional Patent Application No. 63/447,795 filed Feb. 23, 2023, which is incorporated herein by reference.

### BACKGROUND

The present disclosure is generally directed to the fields of communications, software and encoding, including, for example, to methods, architectures, apparatuses, systems related to Multi-AP negotiated target wake time operation.

### SUMMARY

Methods and devices for multiple Access Points (APs) to negotiate Target Wake Times (TWT) operation are discussed and claimed according to the appended claims.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of individual TWT operation defined in 802.11ax;

FIG. 3 illustrates an example of broadcast TWT operation defined in 802.11ax;

FIG. 4 illustrates an example architecture for neighboring APs with overlapping service area to negotiate TWT;

FIG. 5a illustrates an example Enhanced Control field format in an enhanced TWT element;

FIG. 5b illustrates an example Modified Individual TWT Parameter Set field;

FIG. 5c illustrates a Modified Broadcast TWT Parameter Set field;

FIG. 6 illustrates an example interpretation of Negotiation Type subfield and of Target Wake Time, TWT Wake Interval Mantissa, and TWT Wake Interval Exponent Subfields in the case where the Negotiation between APs subfield in the Enhanced Control Field is equal to 1.

FIG. 7 illustrates an example of Modified Broadcast TWT Recommendation field for a broadcast TWT element.

FIG. 8 illustrates an example of enhanced TWT frame exchanges for TWT negotiation between APs—Overlapping TWT (overlapping TWT SPs and overlapping operational channels of AP1 TWT and AP2 TWT);

FIG. 9 illustrates an example of enhanced TWT frame exchanges for TWT negotiation between APs—Non-overlapping TWT;

FIG. 10 illustrates an example of individual TWT operation after APs' negotiation;

FIG. 11 illustrates an example of Individual TWT operation with extended doze duration after AP's negotiation;

FIG. 12 illustrates an exemplary architecture of MAP for power saving (doze) mode negotiation;

FIG. 13 illustrates an example of Modified Broadcast TWT parameter Set field format;

FIG. 14 illustrates an example of enhanced TWT frame exchanges for TWT negotiation between APs—Power saving time/duration negotiation; and

FIG. 15 is a flow chart illustrating a method according to an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### ABBREVIATIONS AND ACRONYMS

AIFS Arbitration Interframe Space
AP Access Point
BSS Basic Service Set
CDMA code division multiple access
C-MAP Coordinated Multi Access Point
CSMA/CA Carrier Sense Multiple Access with Collision Avoidance
CN Core Network
DIFS Distributed Interframe Space
DL Download
DLS Direct Link Setup
DS Distribution System
EHT Extremely High Throughput
HT High Throughput
ID Identifier
IBSS Independent BSS
IFFT Inverse Fast Fourier Transform
MAC Medium Access Control
MLD Multi-Link Device
MTC Meter Type Control
PS Power Save (mode)
PSR Parametrized Spatial Reuse
QoS Quality of Service
RAN Radio Access Network
RB Resource Block
RAT Radio Access Technology
RF Radio Frequency
RIFS Reduced Interframe Space
R-TWT Restricted Target Wake Times
RX Receive/reception
SP Service Period
SG Study Group
SIFS Short Interframe Space
STA Station
TBTT target Beacon Transmission Time
TDLS Tunneled DLS
TSF Timing Synchronization Function
TVWS TV White Space
TWT Target Wake Time
TX Transmit/transmission
TXOP Transmission Opportunity
UE User Equipment (see WTRU)
UHR Ultra-High Reliability
UL Upload
VHT Very HT
WLAN Wireless Local Area Network
WTRU Wireless Transmit-Receive Unit (see UE, STA)

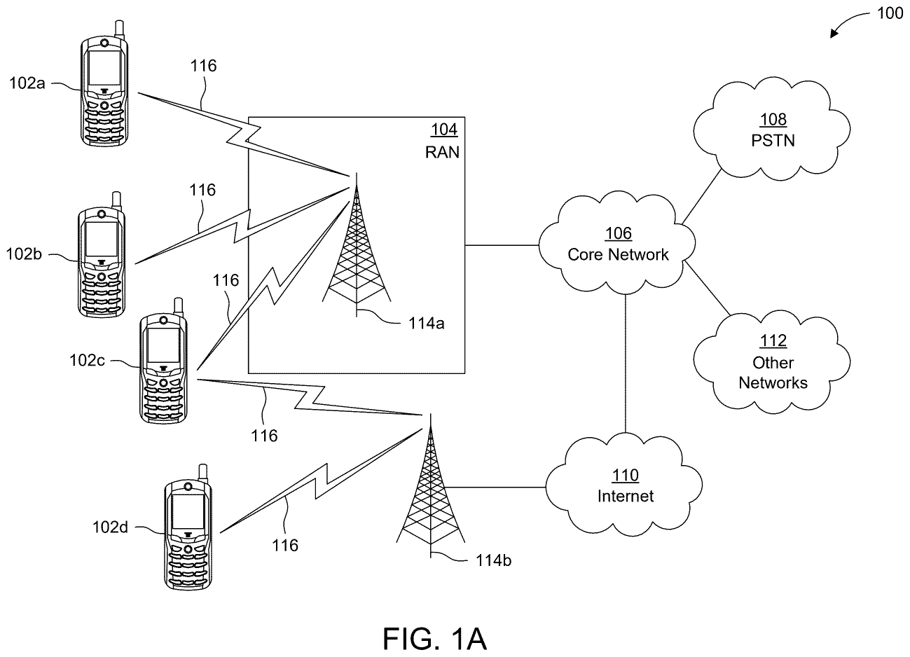

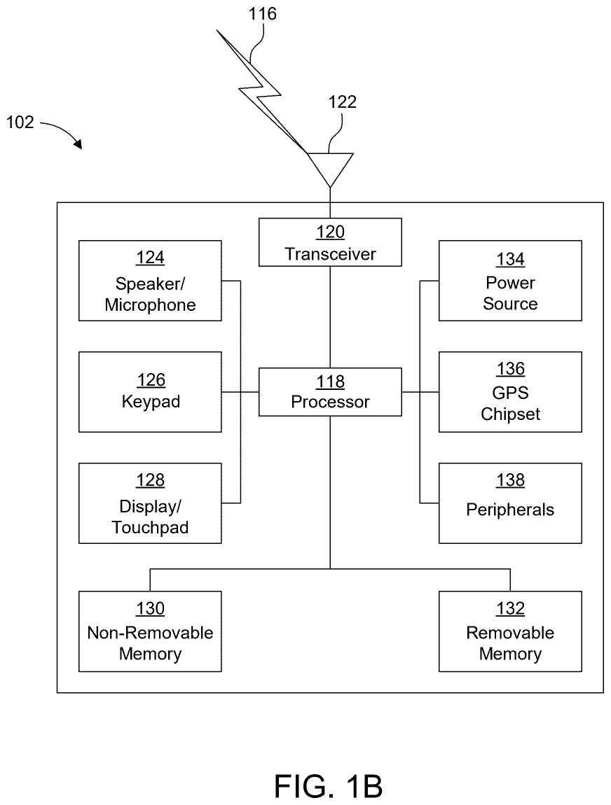

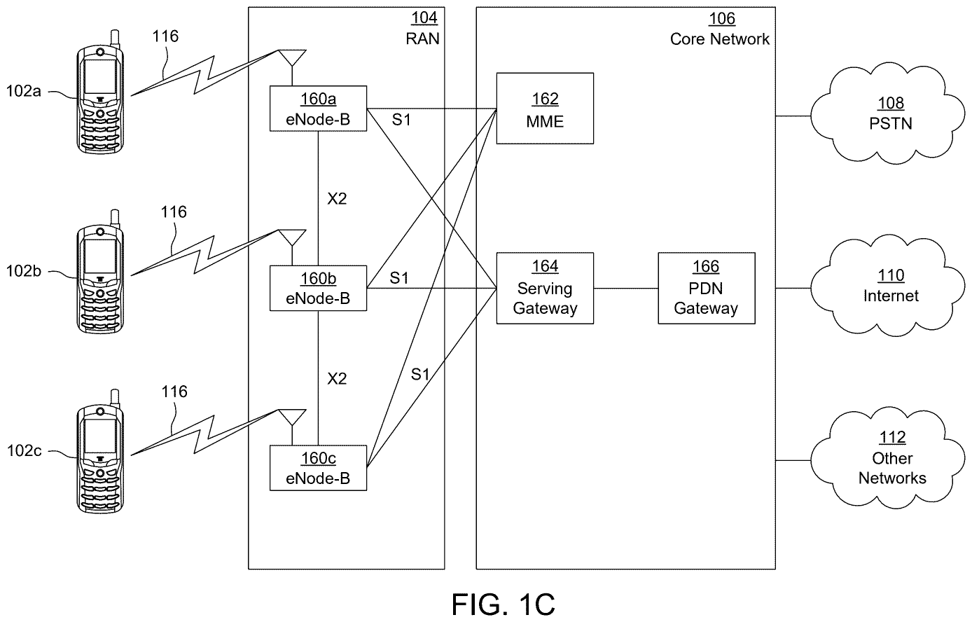

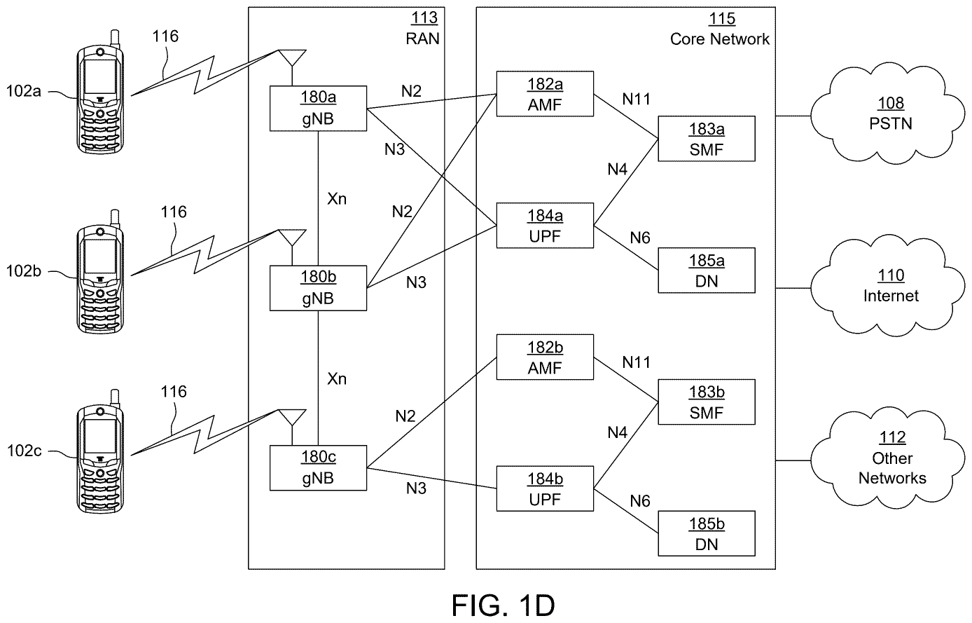

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS). a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface, The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QOS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the features and elements described above are described in the preferred embodiments in particular combinations, each feature or element can be used alone without the other features and elements of the preferred embodiments or in various combinations with or without other features and elements of the present invention. Although the solutions described herein consider 802.11 specific protocols, it is understood that the solutions described herein are not restricted to this scenario and are applicable to other wireless systems as well.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

In the following, the term network node or device may be used to indicate an Access Point (AP), and the term WTRU may be used to indicate a station (STA). A WTRU may perform the function of a network node.

### Overview of WLAN Systems

A WLAN in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA. Such traffic between STAs within a BSS is really peer-to-peer traffic. Such peer-to-peer traffic may also be sent directly between the source and destination STAs with a direct link setup (DLS) using an 802.11e DLS or an 802.11z tunneled DLS (TDLS). A WLAN using an Independent BSS (IBSS) mode has no AP, and/or STAs, communicating directly with each other. This mode of communication is referred to as an “ad-hoc” mode of communication.

Using the 802.11ac infrastructure mode of operation, the AP may transmit a beacon on a fixed channel, usually the primary channel. This channel may be 20 MHz wide, and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the primary channel. If the channel is detected to be busy, the STA backs off. Hence only one STA may transmit at any given time in a given BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel.

In 802.11ac, Very High Throughput (VHT) STAs may support 20 MHz, 40 MHz, 80 MHz, and 160 MHz wide channels. The 40 MHz, and 80 MHz, channels are formed by combining contiguous 20 MHz channels similar to 802.11n described above. A 160 MHz channel may be formed either by combining 8 contiguous 20 MHz channels, or by combining two non-contiguous 80 MHz channels, this may also be referred to as an 80+80 configuration. For the 80+80 configuration, the data, after channel encoding, is passed through a segment parser that divides it into two streams. IFFT, and time domain, processing are done on each stream separately. The streams are then mapped on to the two channels, and the data is transmitted. At the receiver, this mechanism is reversed, and the combined data is sent to the MAC.

Sub 1 GHz modes of operation are supported by 802.11af, and 802.11ah. For these specifications the channel operating bandwidths, and carriers, are reduced relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. A possible use case for 802.11ah is support for Meter Type Control (MTC) devices in a macro coverage area. MTC devices may have limited capabilities including only support for limited bandwidths, but also include a requirement for a very long battery life.

WLAN systems which support multiple channels, and channel widths, such as 802.11n, 802.11ac, 802.11af, and 802.11ah, include a channel which is designated as the primary channel. The primary channel may, but not necessarily, have a bandwidth equal to the largest common operating bandwidth supported by all STAs in the BSS. The bandwidth of the primary channel is therefore limited by the STA, of all STAs in operating in a BSS, which supports the smallest bandwidth operating mode. In the example of 802.11ah, the primary channel may be 1 MHz wide if there are STAs (e.g. MTC type devices) that only support a 1 MHz mode even if the AP, and other STAs in the BSS, may support a 2 MHz, 4 MHz, 8 MHz, 16 MHz, or other channel bandwidth operating modes. All carrier sensing, and NAV settings, depend on the status of the primary channel; i.e., if the primary channel is busy, for example, due to a STA supporting only a 1 MHz operating mode is transmitting to the AP, then the entire available frequency bands are considered busy even though majority of it stays idle and available.

In the United States, the available frequency bands which may be used by 802.11ah are from 902 MHz to 928 MHz. In Korea it is from 917.5 MHz to 923.5 MHz; and in Japan, it is from 916.5 MHz to 927.5 MHz. The total bandwidth available for 802.11ah is 6 MHz to 26 MHz depending on the country code.

### TWT and Restricted TWT

Target wake time (TWT) operation was originally introduced in 802.11ah. It was designed to allow an AP and its associated STAs to negotiate a wake-up time period on which the STAs may transmit and receive traffic. In other words, the STAs and the AP reach a TWT agreement that defines when a STA is awake to receive and send data, so that the STA may only wake up at TWT sessions, and remain in sleep mode the rest of the time, thereby saving power and extending battery life. 802.11ax extended the usage of TWT to allow an AP to manage activity in the BSS in order to minimize contention between STAs and reduce the required amount of time that a STA utilizing a power management mode needs to be awake. TWT element is defined to carry information used to negotiate and advertise TWT related information. Two types of TWTs are defined: broadcast TWT and individual TWT.

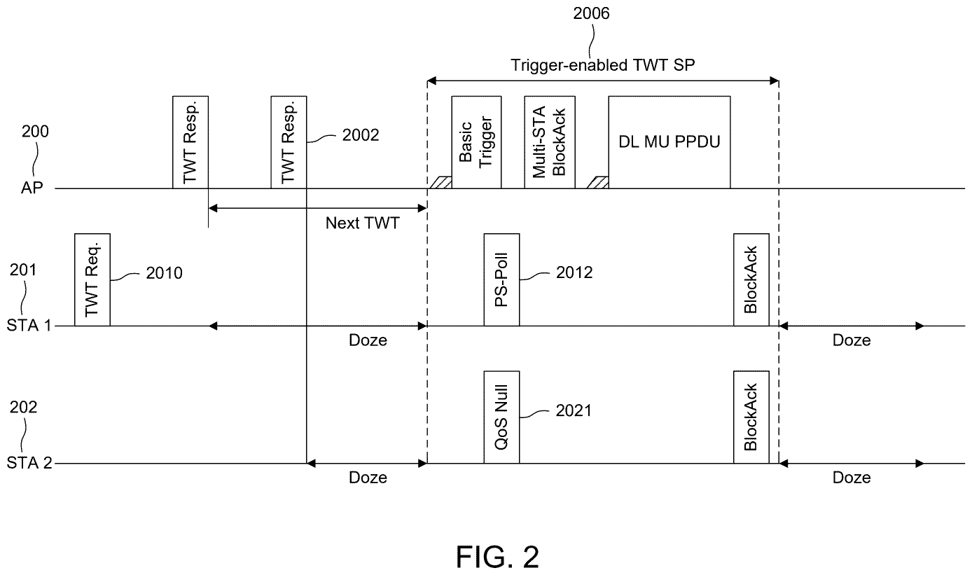

An example of individual TWT operation given in 802.11ax is shown in FIG. 2. A TWT scheduled STA, i.e., STA1 201, may send a TWT request 2010 to a TWT responding STA (e.g., an AP 200) to setup a trigger enabled TWT agreement. The AP accepts the TWT agreement. The AP may send an unsolicited TWT response 2002 to STA 2 202 to setup a trigger enabled TWT agreement with STA2. Then the AP may start a Trigger-enabled TWT service period (SP) 2006 with a Trigger frame. STA1 and STA2 may respond with a PS-Poll frame 2012 and a QoS Null frame 2021 respectively to indicate they are awake and ready to communicate with the AP.

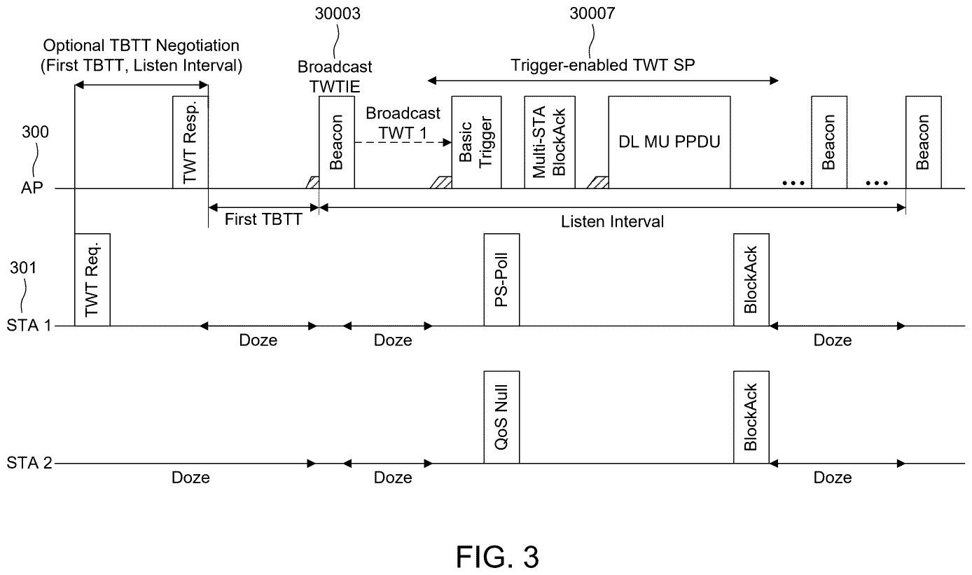

An example of broadcast TWT operation given in 802.11ax is shown FIG. 3. A TWT scheduled STA, i.e., STA1 301, may negotiate with a TWT scheduling AP 300 for the first wake target Beacon Transmission Time (TBTT) to listen to the Beacon frame 30003. The AP may advertise the broadcast TWT element in the Beacon. Then the AP may start a Trigger-enabled TWT service period (SP) 30007. In the TWT SP, one or more STAs may wake up and communicate with the AP.

The IEEE Standard board approved the IEEE 802.11be Task Group (TG) based on a Project Authorization Request (PAR) and Criteria for Standards Development (CSD) developed in the EHT SG. Restricted TWT (R-TWT) was introduced in 802.11be. R-TWT is designed to prioritize latency sensitive traffic by including Restricted TWT Traffic Info field in the broadcast TWT element.

### Introduction on Ultra High Reliability (UHR) Study Group

The IEEE 802.11 Ultra High Reliability (UHR) Study Group was formed in September 2022. UHR is considered as the next major revision to IEEE 802.11 standards following 802.11be, which is currently in the Working Group Letter Ballot Stage. UHR is formed to explore the possibility to improve reliability, support low latency traffic and further increase peak throughput and improve efficiency of the IEEE 802.11 networks.

Coordinated Multi-AP (C-MAP) transmissions was discussed in 802.11be and UHR SG. C-MAP allows two or more APs to coordinate and to concurrently transmit to a set of STAs. The schemes having been discussed include Coordinated Multi-AP OFDMA (co-OFDMA); Coordinated Multi-AP TDMA (co-TDMA); Coordinated Multi-AP Spatial Reuse (CSR); Coordinated beamforming/nulling (CBF); Joint Transmission (JTX).

In the context of coordinated Multi-AP, several terminologies have been defined.
Sharing AP: An EHT AP which obtains a TXOP and initiates the multi-AP coordination.
Shared AP: An EHT AP which is coordinated for the multi-AP transmission by the sharing AP.
AP candidate set: A set of APs that can initiate or participate in multi-AP coordination.

Among others, the problems of negotiation mechanisms of AP Scheduled TWT in C-MAP, and AP Power Saving Mode Negotiation in C-MAP will be addressed here.

### Negotiation Mechanisms of AP Scheduled TWT in C-MAP

When multiple APs operate within a same C-MAP set, they may have overlapping service areas. They may have overlapping TWT SPs, which means that their operating channel or service periods may be overlapping or partially overlapping. Therefore, it is advantageous to contemplate a mechanism to support the negotiation of the TWT operational parameters (configuration settings) between APs, e.g., TWT SP start time/duration, transmission power setting, etc. such that the transmissions within each AP's TWT SP do not interfere with each other.

### AP Power Saving Mode Negotiation in C-MAP

To save operating power, an AP may go to power saving mode, in which an AP may not perform any transmission or reception. However, when the AP goes to power saving mode, its associated STA(s) may be out of service as a consequence. Therefore, there is a need to develop a mechanism for power saving mode negotiation between APs in C-MAP, so as to guarantee that at least one AP in vicinity (within the same C-MAP as the AP in power saving mode) is awake and may therefore serve STA(s) that are associated with the AP that is in power saving mode.

### Representative Negotiation Mechanisms of AP Scheduled TWT in C-MAP

The embodiments discussed here address the issues raised above related to negotiation mechanisms of AP Scheduled TWT in C-MAP.

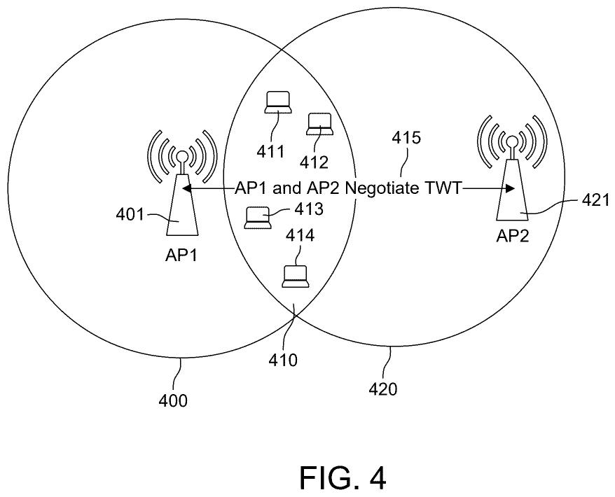

Multiple APs that are in vicinity of each other may have overlapping service areas as indicated in FIG. 4. FIG. 4 depicts an exemplary scenario where two APs, 401 and 421, share their service areas 400 and 420, e.g., WTRUs 411-414 are in overlapping service area 410 To minimize the interference between the transmission within each AP coverage or maintain the desired link quality, especially in AP scheduled TWT SP, APs which are collocated or have overlapping service areas, as depicted in FIG. 4, may need to coordinate the TWT/R-TWT schedule, 415, to achieve multiple goals: 1) minimize the interference between STAs transmitting in TWT SP when the TWT SPs in the neighboring APs are overlapped; 2) maximize the transmission power when there is no overlapping TWT SPs in the neighboring APs; 3) maximize the usage of clear channels for TWT SP transmission.

### Representative Negotiation Mechanisms of AP Scheduled TWT in C-MAP: Enhanced TWT Element

According to an embodiment, the neighboring APs which have overlapping service area, e.g., share the same AP group ID, may negotiate the TWT operation and may come to a TWT operation agreement. The TWT operation agreement may include configurations such as the operating channel for the TWT assigned to each AP, the potential (or allowed) TWT SP time and duration, the transmit power, etc. After the TWT agreements are set up among APs, the AP may use the assigned TWT SP to serve its associated STA(s) with the agreed parameters (configuration), e.g., operating channel(s) or subchannel(s), power and duration etc. The negotiated TWT may include broadcast TWTs or individual TWTs.

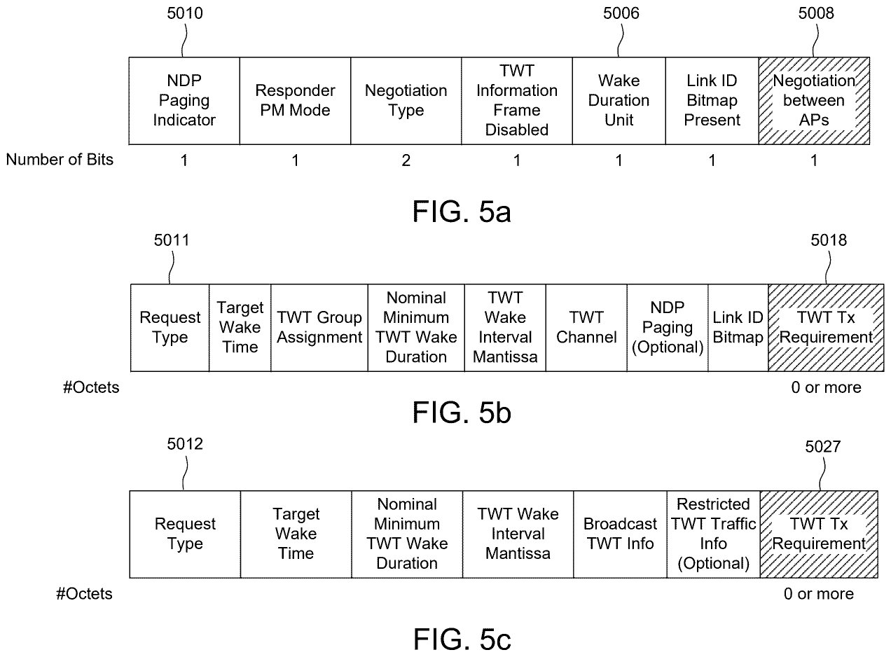

FIG. 5a depicts an example of an enhanced control field format in an enhanced TWT element 5010 according to an embodiment. This enhanced TWT element has an enhanced Control field; in contrast with a conventional (non-enhanced) TWT element, the enhanced TWT element includes a ‘Negotiation between APs’ subfield 5008, which may indicate whether the TWT is a legacy TWT element or whether the TWT element is an enhanced TWT element. The enhanced control field may be used for negotiation of TWT setup between APs. For example, if the Negotiation between APs subfield 5008 is set to 1, this means that TWT element 5010 includes an enhanced control field 5008 which shows the TWT negotiation between APs; otherwise, for example if field 5008 is set to 0, this indicates that this TWT is a TWT element between AP and non-AP STA, e.g., a legacy TWT. If Negotiation between APs control field 5008 is equal to 1, then a TWT Tx Requirement field 5018/5027 according to an embodiment may be included in the Individual TWT Parameter Set field 5011 or the Broadcast TWT Parameter Set field 5012. Examples of modified Individual TWT Parameter Set field and modified Broadcast TWT Parameter Set field are depicted in FIG. 5b and FIG. 5c respectively.

According to an embodiment, multiple information may be included in in the TWT Tx Requirement field (e.g., 5018, 5027) when the TWT negotiation is exchanged between APs: 1) AP group ID: indicate the group that the AP belongs to, e.g., the APs served by the same virtual AP may have the same AP group ID, or the APs which have the overlapping service areas may have the same AP group ID; 2) Spatial Reuse information, e.g., PSR: may indicate the minimum received interference or minimum received power from the transmission in the overlapping TWT. The neighboring AP and its associated STAs may need to follow the power setup rule derived from this parameter on the overlapping channel during the overlapped TWT SP; 3) STAs IDs: the IDs of STAs that will be served in the negotiated TWT SP; 3) TWT operating channel or operating link.

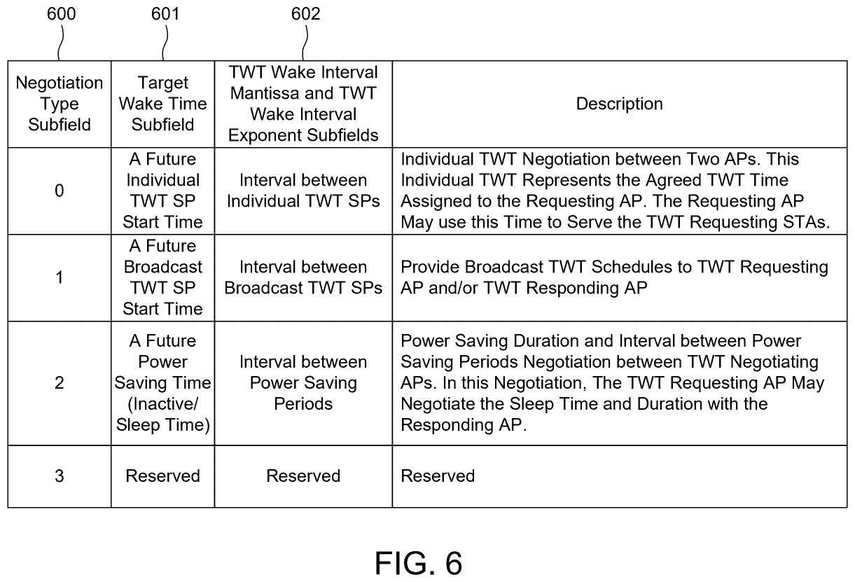

According to an embodiment, if the TWT negotiation is exchanged between APs, i.e., a TWT element having the Negotiation between APs subfield 5008 set to 1, may be differently interpreted than a legacy TWT element, i.e., a TWT element having the Negotiation between APs subfield 5008 set to 0. FIG. 6 gives an example interpretation of Negotiation Type subfield 600 and of Target Wake Time 601, TWT Wake Interval Mantissa and TWT Wake Interval Exponent 602 subfields according to an embodiment, in the case where the Negotiation between APs subfield 5008 in the Enhanced Control field is equal to 1. For example, a Negotiation Type subfield 600 set to a value 0, may be used for individual TWT negotiation between two APs. In this case, Target Wake Time subfield may indicate a future individual TWT SP start time. The TWT Wake Interval mantissa and TWT Wake Interval Exponent subfields may represent the interval between individual TWT SPs. This case may represent an agreed TWT time assigned to the requesting AP. The requesting AP may use this time to serve its TWT requesting STAs. For example, when the Negotiation Type subfield 600 is set to a value 1, in order to provide broadcast TWT schedules to TWT requesting AP and/or TWT responding AP, the Target Wake Time subfield 601 may indicate a future broadcast TWT SP start time, and the TWT Wake Interval mantissa and TWT Wake Interval Exponent subfields 602 may indicate an interval between broadcast TWT SPs. For example, if the Negotiation Type subfield 600 is set to a value 2, in order to provide power saving duration and interval between power saving periods negotiation between TWT negotiating APs, where in this negotiation, the TWT requesting AP may negotiate the sleep time and duration with the responding AP, the Target Wake Time subfield 601 may indicate a future power saving time (inactive/sleep time), and the TWT Wake Interval mantissa and TWT Wake Interval Exponent subfields 602 may indicate an interval between power saving periods.

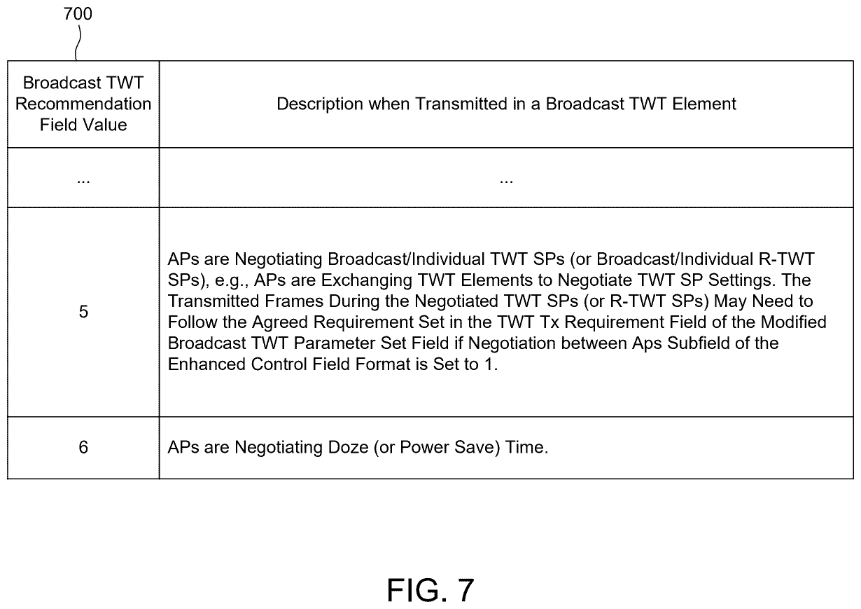

FIG. 7 gives an example of the values of Modified Broadcast TWT Recommendation field 700 for a broadcast TWT element according to an embodiment. In this example, when the Broadcast TWT Recommendation field 700 value is equal to 5, it means that APs are exchanging the TWT element to negotiate the settings in broadcast/individual TWT SPs or broadcast R-TWT SPs, e.g., the Negotiation Type subfield in the Enhanced Control field is set to 0 or 1 (as indicated in FIG. 6). The transmitted frames during the negotiated TWT SPs (or R-TWT SPs) may need to follow the agreed transmission requirement set in the TWT Tx Requirement field of the modified Broadcast TWT Parameter Set field. If the Broadcast TW Recommendation field 700 value is set to 6, it means APs are negotiating doze start time/duration, e.g., the Negotiation Type subfield in the Enhanced Control field is set to 2 (as indicated in FIG. 6). Please note that the value order in this table may be changed.

### Representative Negotiation Mechanisms of AP Scheduled TWT in C-MAP: Negotiation of Broadcast TWT Between APs

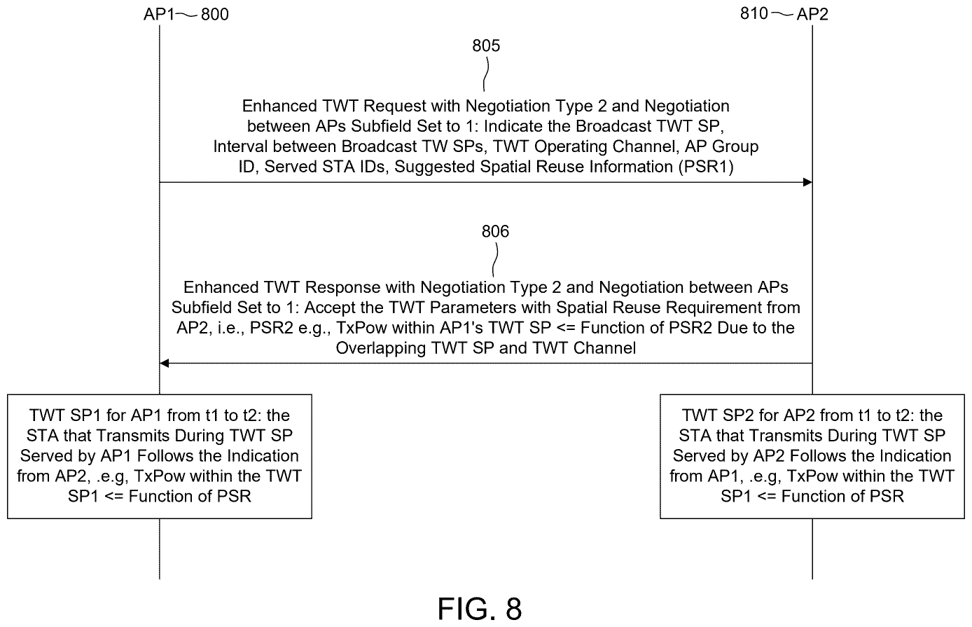

According to an embodiment, APs may negotiate the TWT SP by exchanging enhanced TWT request frame according to embodiments and enhanced TWT responding frame according to embodiments. FIG. 8 depicts the example of enhanced TWT frame exchanges for TWT negotiation between APs in the case of overlapping TWT. In this example, AP1 800, the TWT requesting AP, transmits an enhanced TWT request 805 to AP2 810, with Negotiation type 2, which indicates the negotiation of the broadcast TWT SP. This TWT request 805 may include the TWT element with the enhanced Control field as indicated in FIG. 5a by setting the Negotiation between APs subfield 5008 to 1. The request frame may also include information as follows: the interval between broadcast TW SPs, the future broadcast TWT SP start time, AP group ID, the IDs of STAs that are served by AP1, the suggested spatial reuse information, e.g., PSR1. Upon reception of this enhanced TWT request frame, AP2 810 responds 806 with the Enhanced TWT Response frame with Negotiation type 2 and Negotiation between APs subfield set to 1. This Enhanced TWT Response frame indicates that AP2 810 acknowledges the broadcast TWT information transmitted by AP1 and indicates that AP2 accepts the parameters suggested by AP1. Since AP1 and AP2 are in the vicinity, e.g., in the same C-MAP set or belong to the same group, i.e., have the same group ID, the TWT broadcast SPs of AP1 and AP2 are overlapping, e.g., the TWT operating channels of AP1 and AP2 are overlapping and the TWT SPs of AP1 and AP2 are overlapping (both TWT SPs start from time 1, t1 to time 2, t2), AP2 also suggests PSR information, PSR2, which is included in the Enhanced TWT Response frame from AP2. The STAs which perform transmission within TWT SP of AP1 may need to set the transmission power in terms of function of PSR2. Similarly, the STAs which perform transmission within TWT SP of AP2 may need to set the transmission power in terms of function of PSR1. Note that the TWT operating channels of AP1 and AP2 may be partially overlapped. The transmission powers on the overlapped channel within AP1 TWT and AP2 TWT2 may need to follow PSR2 and PSR1 respectively.

Alternatively, the TWT responding AP, e.g., AP2 in FIG. 8 may decline the parameters suggested by the TWT requesting AP, e.g., AP1 in FIG. 8. In this case, negotiating APs, e.g., AP1 and AP2 do not make an agreement on TWT operation and AP1 may not set up TWT SP during the requested time.

The above protocol may be applied to the negotiation between two AP MLDs or APs affiliated with the same MLD.

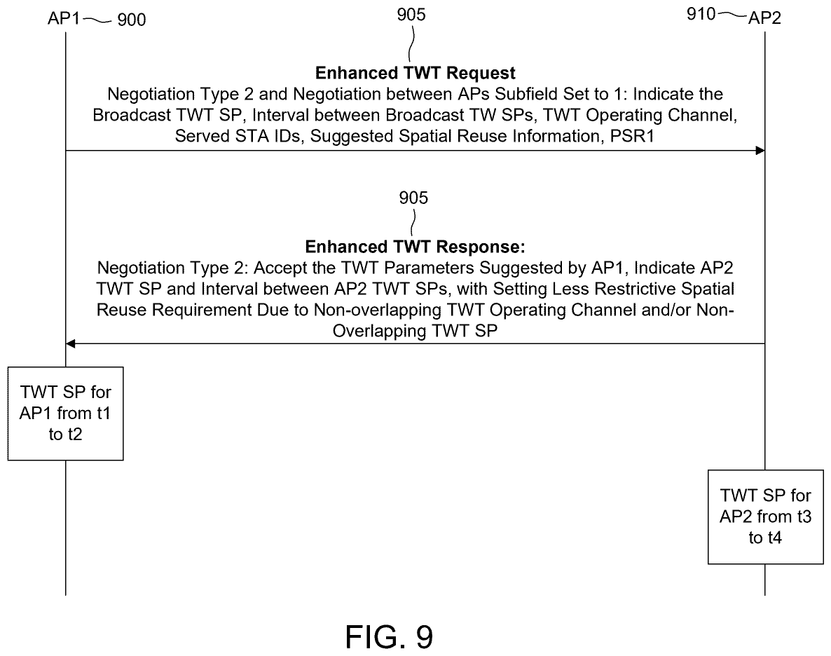

FIG. 9 depicts an example embodiment of enhanced TWT frame exchanges for TWT negotiation between APs in the case of non-overlapping TWT. In this example, AP1 900, i.e., the TWT requesting AP, transmits an enhanced TWT request 905, with Negotiation type 2 to AP2 910, which indicates the negotiation of the broadcast TWT SP. This TWT request 905 may include the TWT element with the enhanced Control field as indicated in FIG. 5a by setting the Negotiation between APs subfield 5008 to 1. The request frame 905 may also include information as follows: the interval between broadcast TW SPs, the future broadcast TWT SP start time, AP group ID, the IDs of STAs that are served by AP1 900, the suggested spatial reuse information, e.g., PSR1. Upon reception of this enhanced TWT request frame 905, AP2 910 responds 906 with the Enhanced TWT Response frame with Negotiation type 2 and Negotiation between APs subfield set to 1. AP2 910 determines that the TWT SPs between AP1 and AP2 may not be overlapping. It accepts all parameters suggested by AP 1 900 and may not set PSR requirement information (e.g., less restrictive requirement or higher minimum interference value in the PSR information in the TWT Tx Requirement field) in the responding frame. It may also indicate its TWT operating channel, TWT SP and interval between TWT SPs. As indicated in FIG. 9, the TWT SP of AP 1 900 is from time 1 to time 2, i.e., t1 to t2 and the TWT SP of AP2 is from time 3 to time 4, i.e., t3 to t4. Since the TWT SPs of AP1 900 and AP2 910 are not overlapping, the transmission power of STAs in TWT SP served by AP1 900 and served by AP2 910 may not be restrictive, e.g., less restrictive PSR requirement set in the PSR Information of the TWT Tx Requirement field of the TWT element.

For example, if the TWT SPs of AP1 and AP2 are overlapping (as shown in FIG. 8, AP1 800 and AP2 810), following the PSR information defined by AP2 and AP1, the transmission power of AP1 and AP2 during the negotiated TWT SPs may be set as P11 and P21 respectively. If the TWT SPs of AP1 and AP2 are not overlapping (as shown in FIG. 9), the transmission power of AP1 and AP2 to the STAs which are same as the overlapping TWT case are P12 and P22 respectively. P11 may be smaller than P12 and P21 may be smaller than P22.

### Representative Negotiation Mechanisms of AP Scheduled TWT in C-MAP: Negotiation of Individual TWT Between APs

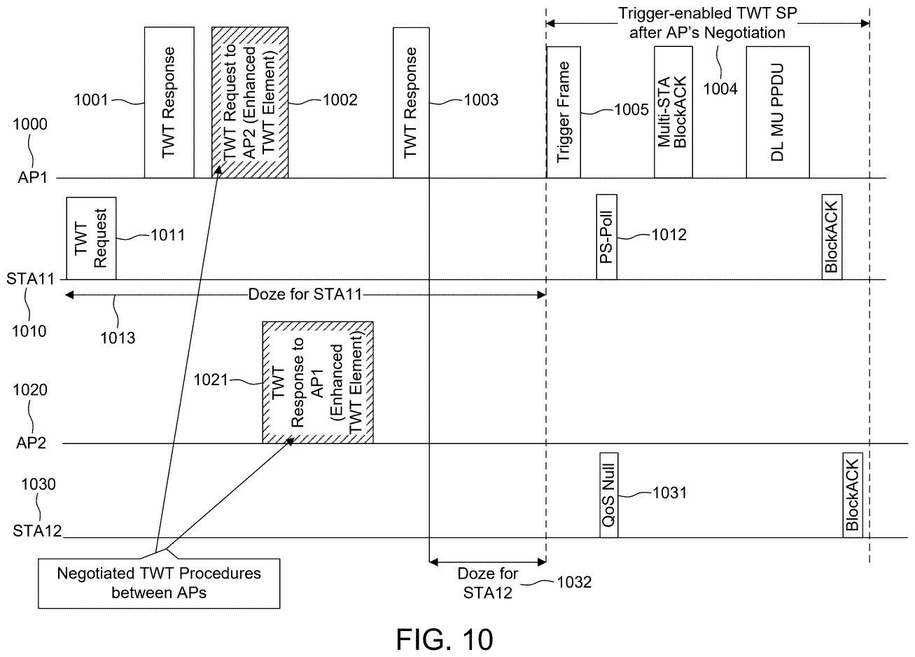

In one embodiment, APs which may be in the same C-MAP may want to negotiate individual TWT after the non-AP STA send the request for TWT SP from its associated AP. FIG. 10 depicts an example of individual TWT operation after APs'negotiation. In this example, STA11 1010 and STA12 1030 are associated with AP1 1000; AP1 1000 and AP2 1020 are in the same C-MAP set. STA11 1010 sends a TWT request 1011 to the TWT responding STA, AP1 1000, to setup a trigger-enabled TWT agreement. The TWT responding STA, AP1 1000, accepts the TWT agreement with STA11 1010 and confirms the acceptance in the TWT response 1001 sent to STA11 1010. Subsequently, AP1 1000 sends a TWT Request 1002 which includes an enhanced TWT element, e.g., using the format shown in section “Enhanced TWT element”, to AP2 1020. AP2 1020 responds with a TWT Response 1021 which includes an enhanced TWT element, e.g., using the format shown in section “Enhanced TWT element”, to AP1 1000. Upon reception of the TWT response 1021 from AP2 1020, AP1 1000 sends an unsolicited TWT response 1003 to STA 12 1030 to set up a trigger-enabled TWT agreement with STA 12 1030. Both these TWT agreements (between AP1 1000 and STA11 1010 and between AP1 1000 and STA12 1030) are set up as announced TWTs. During the trigger-enabled TWT SP 1004, the TWT responding STA, AP1 1000, sends a Basic Trigger frame 1005 to which the TWT requesting STAs indicate that they awake during the TWT SP. STA11 1010 indicates that it is awake by sending a PS-Poll frame 1012, and STA12 1030 indicates that is awake by sending a QOS Null frame 1031 in response to the Basic Trigger frame 1005. STA11 1010 and STA21 1030 receive their DL BUs in a subsequent exchange with AP 1 1000 and go to doze state 1013 and 1032 outside of this TWT SP. Note in this example the TWT negotiation procedure between APs, e.g., AP1 1000 and AP2 1020, may be transparent to the TWT requesting STA, e.g., STA11 1010 or TWT scheduled STA, e.g., STA12 1030. AP1 1000 may use the trigger frame 1005 to indicate to STA11 1010 and STA12 1030 the transmission requirements which are obtained from the negotiation between AP1 1000 and AP 2 1020.

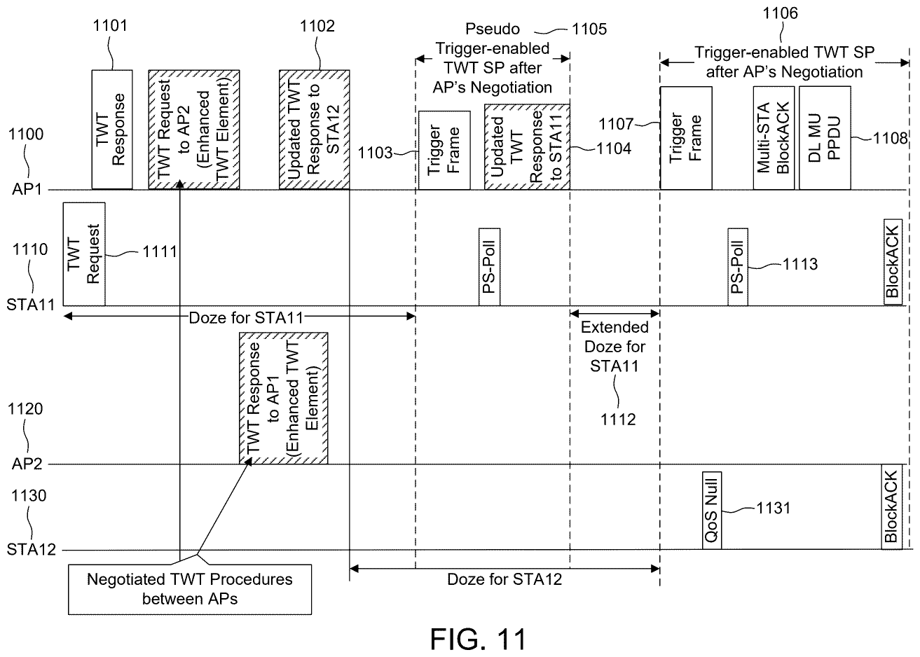

Alternatively, after the TWT negotiation between APs, the AP may determine to extend the doze time of the TWT requesting STA by using a pseudo Trigger-enabled TWT SP, during which the AP, the TWT responding STA may send an unsolicited TWT response to the original TWT requesting STA to indicate the updated (e.g., postponed) TWT SP. FIG. 11 depicts the example of Individual TWT operation with an extended doze duration after AP's negotiation. In this example, TWT negotiation between APs are performed after AP1 1100 sends the TWT response 1101 to the TWT requesting STA, STA11 1110 upon reception of TWT Request 1111 from STA11 1110. The TWT negotiation agreement between APs may decide a new TWT SP starting time which is different from what has been agreed between AP1 1100 and STA11 1110. Subsequently, AP 1 1100 sends an unsolicited TWT response 1102 to its associated STA, STA12 1130, with the updated TWT agreement obtained from the negotiation between AP1 1110 and AP2 1120. During the target wake up time 1105 of STA11 AP1 1110 indicated in the first TWT agreement between AP1 1100 and STA11 1110, AP1 1100 transmits the trigger frame 1103 to the TWT requesting STA, STA11 1110, and STA11 1110 indicates that it is awake during this TWT SP. Subsequently, AP1 1100 sends an unsolicited TWT response 1104 to STA11 1110 to indicate this is a pseudo TWT SP (it may imply that this TWT SP duration is shorter than the originally agreed one) and the next TWT SP for STA11 1110. The pseudo TWT SP 1105 in this example is used for the exchange of updated TWT response/request 1104. In other words, the pseudo TWT SP 1105 may only support the exchange of control or management frame and do not support the transmission of data frames. After the pseudo-Trigger-enabled TWT SP 1105, STA11 1110 goes back to doze mode, 1112, until the updated TWT SP 1104 comes. This doze mode is extended doze duration 1112 for STA11 1110. In the coming TWT SP 1106 (which is determined by the negotiation between AP1 1100 and AP2 1120), AP1 1100 sends the basic trigger frame 1107 to the TWT requesting STA, STA11 1110, and STA12 1130, which indicate they are awake during this TWT SP 1106 by responding with a PS-Poll frame 1113 and a QoS Null frame 1131 respectively. STA11 1110 and STA12 1130 receive their DL BUs (DL MU PPDU) 1108 in a subsequent exchange with AP1 1100 and go to doze state outside of this TWT SP.

### Representative Negotiation of Power Saving Time/Duration Between APs

The embodiments described here address the issues raised above in Embodiment 2: Negotiation of Power Saving Time/Duration between APs.

### Representative Negotiation of Power Saving Time/Duration Between Aps: Modified Broadcast TWT Parameter Set Field for the Negotiation of Power Saving Time/Duration Between APs

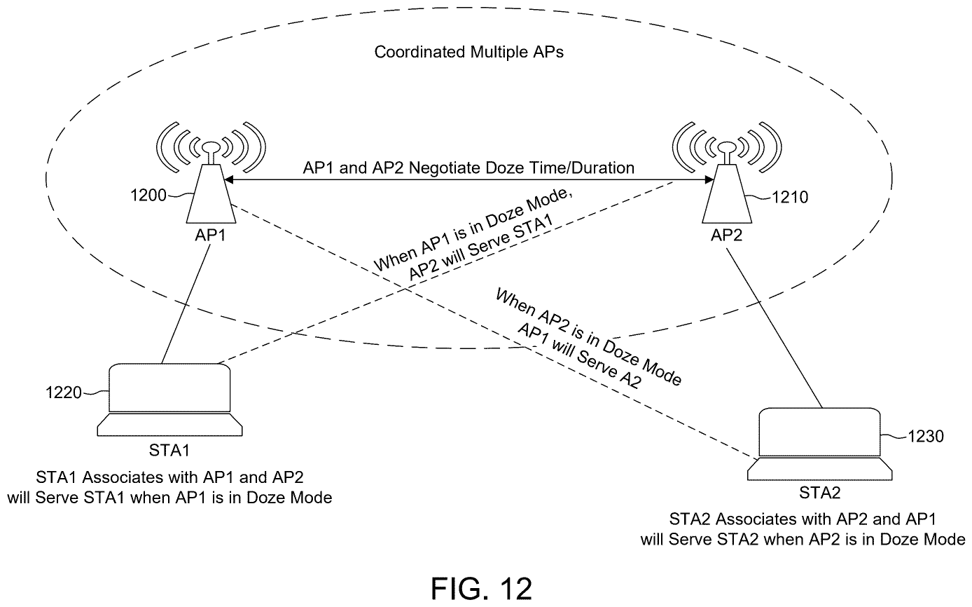

An AP that is in power saving mode may be in a doze state, e.g., not transmitting or receiving the packets. To guarantee that STAs can be served by at least one AP (i.e., that is not in a doze state), the APs which are in the vicinity or collocated, e.g., the APs with the same group ID, may need to coordinate the power saving start time/duration and/or the interval between the power saving periods. FIG. 12 depicts an example architecture when Multi APs are negotiating the power saving mode according to an embodiment. In this example, STA1 1220 is associated with AP1 1200 and STA2 1230 is associated with AP2 1210. AP1 1200 and AP2 1210 are in the same coordinate multiple AP set (C-MAP set). To guarantee the associated STAs 1220 and 1230 can be served by at least one AP, AP1 1200 and AP2 1210 are negotiating their individual doze mode starting time/duration/periodicity. When AP1 1200 is in doze mode, its associated STA1 1220 will be served by AP2 1210. Similarly, when AP2 1210 is in doze time, its associated STA2 1230 will be served by AP1 1200.

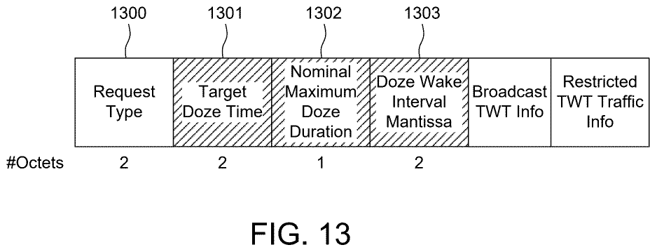

In one embodiment, if APs are negotiating the power saving/duration, e.g., the Negotiation between APs subfield is set to 1 and the Negotiation Type subfield is set to 2, then the requesting AP may need to transmit the enhanced TWT element with the modified Broadcast TWT Parameter Set field. FIG. 13 depicts the example of the modified Broadcast TWT parameter Set field 1300 if the APs are negotiating power saving/duration. The Target Doze Time field 1301 may contain a positive integer corresponding to a TSF time at which the TWT requesting AP intends to be in power saving mode or the TWT responding AP agrees in the power saving mode. Alternatively, the Target Doze Time field 1301 may contain a positive integer corresponding to a TSF time at which the TWT requesting AP requests the TWT responding AP to be in power saving mode. The Nominal Maximum Doze Duration field 1302 may indicate the maximum amount of time, in the unit indicated by the Wake Duration Unit subfield (5006 in FIG. 5a), that the TWT requesting AP or TWT responding AP is expected to be power saving mode. The doze mode may be periodic, the doze interval is indicated in the Doze Wake Interval Mantissa field 1303. For example, according to an embodiment, the Doze Wake Interval Mantissa subfield may be set to the value of the mantissa of the TWT doze interval value in microseconds, base 2.

### Representative Negotiation of Power Saving Time/Duration Between Aps: Procedures of Negotiation of Power Saving Time/Duration Between APs

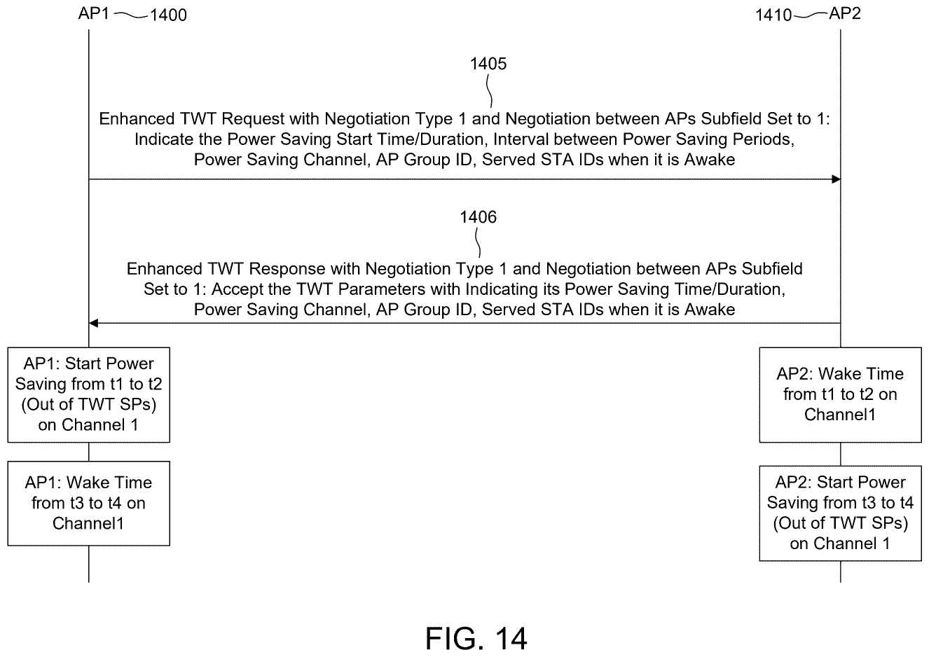

In one embodiment, if the APs are negotiating the power saving time/duration, the requesting AP may need to transmit the enhanced TWT element to the responding AP and make an agreement on the power saving time/duration. FIG. 14 depicts the example of enhanced TWT frame exchanges for power saving time/duration negotiation between APs. In this example, AP1 1400, the TWT requesting AP, transmits an enhanced TWT request 1405, with Negotiation Type 1, which indicates the negotiation of the power saving starting time/duration. This TWT request may include the TWT element with enhanced Control field as indicated in FIG. 5a by setting the Negotiation between APs subfield to 1. The request frame 1405 may also include information as follows: the future power saving time start/duration, the interval between power saving periods, power saving channel (which indicates the channel ID or the link ID the AP will perform power saving mode), AP group ID, the IDs of STAs that are served by AP1 1400. Upon reception of this enhanced TWT request frame, AP2 1410 responds with the Enhanced TWT Response frame 1406 with Negotiation type 1 and Negotiation between APs subfield set to 1. AP2 1410 accepts the parameters proposed by AP1 1400 in the enhanced TWT requesting frame 1405 and indicates, in its response 1406, its power saving start time/duration, power saving channel, AP group ID and the STA IDs served by AP2 1410. Note that AP1 1400 and AP2 1410 may have some overlapping coverage areas. In other words, AP1 1400 (or AP2 1410) may be able to serve the STAs which are associated with AP2 1410 (or AP1 1400) when AP2 1410 (or AP1 1400) is in the power saving mode, i.e., doze state. After the power saving agreement is set up, AP1 1400 starts the power saving period from time 1 to time 2, i.e., t1 to t2 on channel 1; meanwhile, AP2 1410 stays in wake mode and serves the STAs which are associated with AP1 1400 on channel 1. When it comes to Time 3, AP2 1410 starts power saving period until Time 4, i.e., AP2 1410 in power saving mode from t3 to t4 on channel 1; meanwhile, AP 1 1400 stays in wake mode and serves the STAs which are associated with AP 2 1410 on channel 1.

Alternatively, AP2 may not accept the suggested power saving parameters from AP1 or AP1 may not accept the suggested power saving parameters from AP2. Then AP1 may not start the power saving mode from t1 to t2 and AP2 may not start the power saving mode from t3 to t4.

Note that the negotiation may be between two AP MLDs or APs affiliated with the same MLD. The channel that the AP is on doze mode (power saving mode) may be fully/partially overlapped with another AP that it negotiated with, or these two APs may not have a shared channel.

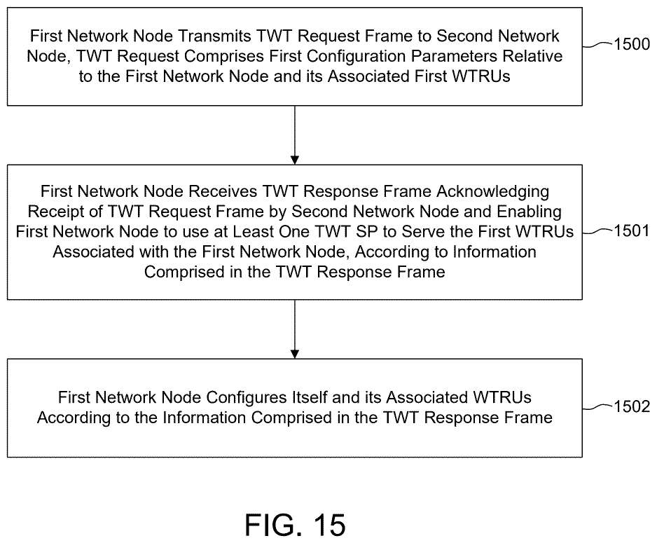

FIG. 15 is a flow chart illustrating a method performed by a first network node (e.g., a device or a WTRU performing the functions of a network node or AP) according to an embodiment.

In 1500, the first network node transmits, to a second network node (or a second WTRU performing the functions of a network node) in an overlapping service area with the first network node, a target wake time (TWT) request frame indicating, and/or comprising information indicating, a request for negotiation of at least one TWT service period (SP) between the first network node and the second network node. The TWT request comprising, and/or comprising information indicating, (suggested) first configuration parameters relative to the first network node and relative to first wireless transmit-receive units (WTRUs) associated with the first network node.

In 1501, the first network node receives, from the second network node, a TWT response frame acknowledging receipt by the second network node of the TWT request frame sent by the first network node and enabling the first network node to use at least one TWT service period to serve the first WTRUs associated with the first network node according to information comprised in the TWT response frame;

In 1502, the first network node configures itself and the first WTRUs associated with the first network node according to the information comprised in the TWT response frame received from the second network node. If the information comprised in the TWT response frame indicates that the second network node accepts the first configuration parameters, the first network node may configure itself and its associated WTRUs, according to the first configuration parameters, if the first network node and the WTRUs associated with it are not already configured as such (i.e., if the first network node and the WTRUs associated with the first network node are not already configured according to the first configuration parameters). If the information comprised in the TWT response frame indicates that some or all of the first configuration parameters are not accepted by the second network node, the first network node may configure itself and the WTRUs associated with it according to other configuration parameter values suggested by the second network node and comprised in the TWT response frame, or the first network node may choose not to do so, and may then possibly reiterate the method in order to renegotiate different first configuration parameter value settings as desired, until an agreement is reached with the second network node, or not. This negotiation may include the TWT parameters setting for the TWT operation of the second network node and its associated WTRUs.

According to an embodiment, the TWT response frame comprises a second PSR information, PSR2, different from a suggested first PSR, PSR1, comprised in the TWT request frame; and wherein the first network node configures transmission power configuration parameters of the first WTRUs associated with the first network node according to the PSR2 comprised in the TWT response frame.

According to an embodiment, the overlapping service area is characterized by the first network node and the second network node sharing a same network node group identifier.

According to an embodiment, the TWT request frame comprises, and/or comprises information indicating, at least one of the following configuration parameters relative to the first network node and the first WTRUs associated with the first network node: a power saving start time; a power-saving duration; an interval between power saving periods; a TWT operating channel or TWT operating link; an operating subchannel; a network node group identifier; a suggested first parametrized spatial reuse (PSR) information, PSR1; a transmission power; identifiers of the first WTRUs associated with the first network node.

According to an embodiment, the TWT response frame comprises, and/or comprises information indicating, a second PSR information, PSR2, different from the suggested PSR1 comprised in the TWT request frame. Then, the first network node configures transmission power configuration parameters of the first WTRUs associated with the first network node according to the PSR2 comprised in the TWT response frame.

According to an embodiment, the at least one TWT service period is a broadcast TWT service period and wherein the TWT request frame comprises a negotiation type indicating negotiation of at least one broadcast TWT service period.

According to an embodiment, the TWT request frame comprises, and/or comprises information indicating, at least one of the following configuration parameters relative to the first network node and relative to the first WTRUs associated with the first network node: an interval between broadcast TWT service periods; a future broadcast TWT service period start time; a network node group identifier; identifiers of the first WTRUs associated with the first network node; a suggested first spatial reuse (PSR) information, PSR1.

According to an embodiment, the TWT response frame comprises, and/or comprises information indicating, a second PSR information, PSR2, different from the suggested PSR1 comprised in the TWT request frame. Then, the first network node configures transmission power configuration parameters of the first WTRUs associated with the first network node according to the PSR2 comprised in the TWT response frame.

The present disclosure also relates to an embodiment of a first device (e.g., a network node, or a WTRU performing the functions of a network node) comprising at least one processor configured to transmit, to a second device (e.g., a network node, or a WTRU performing the functions of a network node) in an overlapping service area with the first device, a target wake time (TWT) request frame indicating, and/or comprising information indicating, a request for negotiation of at least one TWT service period (SP) between the first device and the second device, the TWT request comprising, and/or comprising information indicating, first configuration parameters relative to the first device and first wireless transmit-receive units (WTRUs) associated with the first device.

The at least one processor of the first device is further configured to receive, from the second device, a TWT response frame acknowledging receipt by the second device of the TWT request frame sent by the first device and enabling the first device to use at least one TWT service period to serve the first WTRUs associated with the first device according to information comprised in the TWT response frame.

The at least one processor of the first device is further configured to configure the first device and the first WTRUs associated with the first device according to the information comprised in the TWT response frame.

According to an embodiment, the TWT response frame comprises a second PSR information, PSR2, different from a suggested PSR1 comprised in the TWT request frame; and wherein the at least one processor is configured to configure transmission power configuration parameters of the first WTRUs associated with the first device according to the PSR2 comprised in the TWT response frame.

According to an embodiment of the first device, the overlapping service area is characterized by the first device and the second device sharing a same device group identifier.

According to an embodiment of the first device, the TWT request frame comprises, and/or comprises information indicating, at least one of the following configuration parameters relative to the first device and the first WTRUs associated with the first device: a power saving start time; a power-saving duration; an interval between power saving periods; a TWT operating channel or TWT operating link; an operating subchannel; a device group identifier; a suggested first parametrized spatial reuse (PSR) information, PSR1; a transmission power; identifiers of the first WTRUs associated with the first device.

According to an embodiment of the first device, the TWT response frame comprises, and/or comprises information indicating, a second PSR information, PSR2, different from the suggested PSR1 comprised in the TWT request frame; and wherein the at least one processor is configured to configure transmission power configuration parameters of the first WTRUs associated with the first device according to the PSR2 comprised in the TWT response frame.

According to an embodiment of the first device, the at least one TWT service period is a broadcast TWT service period and wherein the TWT request frame comprises, and/or comprises information indicating, a negotiation type indicating negotiation of at least one broadcast TWT service period.

According to an embodiment of the first device, the TWT request frame comprises, and/or comprises information indicating, at least one of the following configuration parameters relative to the first device and relative to the first WTRUs associated with the first device: an interval between broadcast TWT service periods; a future broadcast TWT service period start time; a device group identifier; identifiers of the first WTRUs associated with the first device; a suggested first spatial reuse (PSR) information, PSR1.

According to an embodiment of the first device, the TWT response frame comprises, and/or comprises information indicating, a second PSR information, PSR2, different from the suggested PSR1 comprised in the TWT request frame; and wherein the at least one processor is configured to configure transmission power configuration parameters of the first WTRUs associated with the first device according to the PSR2 comprised in the TWT response frame.

### CONCLUSION

Although the features and elements of the present invention are described in the preferred embodiments in particular combinations, each feature or element can be used alone without the other features and elements of the preferred embodiments or in various combinations with or without other features and elements of the present invention.

Although the solutions described herein consider 802.11 specific protocols, it is understood that the solutions described herein are not restricted to this scenario and are applicable to other wireless systems as well.

Although SIFS is used to indicate various inter frame spacing in the examples of the designs and procedures, all other inter frame spacing such as RIFS, AIFS, DIFS or other agreed time interval could be applied in the same solutions.

Although four RBs per triggered TXOP are shown in some figures as example, the actual number of RBs/channels/bandwidth utilized may vary.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth. Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method performed by a first access point, the method comprising:
transmitting, to a second access point in an overlapping service area with the first access point, an enhanced target wake time (TWT) request frame indicating a request for negotiation and/or coordination of at least one pre-established broadcast TWT service period (SP) between the first access point and the second access point, the enhanced TWT request frame comprising first configuration parameters relative to the first access point and relative to first stations (STAs) associated with the first access point;
receiving, from the second access point, an enhanced TWT response frame acknowledging receipt by the second access point of the enhanced TWT request frame sent by the first access point and the enhanced TWT response frame enabling the first access point to use one or more of the at least one pre-established broadcast TWT SP to serve the first STAs associated with the first access point according to information comprised in the enhanced TWT response frame; and
configuring the first access point and the first STAs associated with the first access point according to the information comprised in the enhanced TWT response frame received from the second access point.

2. The method according to claim 1, wherein the enhanced TWT response frame comprises a second parametrized spatial reuse (PSR) information different from a suggested first PSR information comprised in the enhanced TWT request frame; and wherein the first access point configures transmission power configuration parameters of the first STAs associated with the first access point according to the second PSR information comprised in the enhanced TWT response frame.

3. The method according to claim 1, wherein the overlapping service area is characterized by the first access point and the second access point sharing a same access point group identifier.

4. The method of claim 1, wherein the enhanced TWT request frame comprises information indicating, at least one of the following configuration parameters relative to the first access point and the first STAs associated with the first access point:
a power saving start time;
a power-saving duration;
an interval between power saving periods;
a TWT operating channel;
a TWT operating link;
an operating subchannel;
an access point group identifier;
a suggested first parametrized spatial reuse (PSR) information;
a transmission power; and
identifiers of the first STAs associated with the first access point.

5. The method of claim 1, wherein the enhanced TWT request frame comprises a negotiation type indicating negotiation of the at least one pre-established broadcast TWT SP.

6. The method according to claim 1, wherein the enhanced TWT request frame comprises information indicating, at least one of the following configuration parameters relative to the first access point and relative to the first STAs associated with the first access point:
an interval between at least two pre-established broadcast TWT SPs;
a future broadcast TWT SP start time;
an access point group identifier;
identifiers of the first STAs associated with the first access point; and
a suggested first parametrized spatial reuse (PSR) information.

7. The method according to claim 6, wherein the enhanced TWT response frame comprises a second PSR information, different from the suggested first PSR information comprised in the enhanced TWT request frame; and wherein the first access point configures transmission power configuration parameters of the first STAs associated with the first access point according to the second PSR information comprised in the TWT response frame.

8. The method according to claim 1, wherein any of the first access point and the second access point is an access point.

9. The method according to claim 1, wherein any one or more of the first STAs is a station.

10. A first access point comprising at least one processor configured to:
transmit, to a second access point in an overlapping service area with the first access point, an enhanced target wake time (TWT) request frame indicating a request for negotiation coordination of at least one pre-established broadcast TWT service period (SP) between the first access point and the second access point, the enhanced TWT request frame comprising first configuration parameters relative to the first access point and first stations (STAs) associated with the first access point;
receive, from the second access point, an enhanced TWT response frame acknowledging receipt by the second access point of the enhanced TWT request frame sent by the first access point and the enhanced TWT response frame enabling the first access point to use one or more of the at least one pre-established broadcast TWT SP to serve the first STAs associated with the first access point according to information comprised in the enhanced TWT response frame; and
configure the first access point and the first STAs associated with the first access point according to the information comprised in the enhanced TWT response frame.

11. The first access point according to claim 10, wherein the enhanced TWT response frame comprises a second parametrized spatial reuse (PSR) information, different from a suggested first PSR information comprised in the enhanced TWT request frame; and wherein the at least one processor is configured to configure transmission power configuration parameters of the first STAs associated with the first access point according to the second PSR information comprised in the TWT response frame.

12. The first access point according to claim 10, wherein the overlapping service area is characterized by the first access point and the second access point sharing a same access point group identifier.

13. The first access point of claim 10, wherein the enhanced TWT request frame comprises at least one of the following configuration parameters relative to the first access point and the first STAs associated with the first access point:
a power saving start time;
a power-saving duration;
an interval between power saving periods;
a TWT operating channel;
a TWT operating link;
an operating subchannel;
an access point group identifier;
a suggested first parametrized spatial reuse (PSR) information;
a transmission power; and
identifiers of the first STAs associated with the first access point.

14. The first access point of claim 10, wherein the enhanced TWT request frame comprises a negotiation type indicating negotiation of the at least one pre-established broadcast TWT SP.

15. The first access point according to claim 10, wherein the enhanced TWT request frame comprises at least one of the following configuration parameters relative to the first access point and relative to the first STAs associated with the first access point:
an interval between at least two pre-established broadcast TWT;
a future broadcast TWT SP start time;
an access point group identifier;
identifiers of the first STAs associated with the first access point; and
a suggested first spatial reuse (PSR) information.

16. The first access point according to claim 15, wherein the enhanced TWT response frame comprises information indicating, a second parametrized spatial reuse (PSR) information, different from the suggested first PSR information comprised in the enhanced TWT request frame; and wherein the at least one processor is configured to configure transmission power configuration parameters of the first STAs associated with the first access point according to the second PSR information comprised in the TWT response frame.

17. The first access point according to claim 10, wherein any of the first access point and the second access point is an access point.

18. The first access point according to claim 10, wherein any one or more of the first STAs is a station.

19. The method according to claim 1, wherein the enhanced TWT request includes an enhanced control field for the negotiation and/or coordination of the at least one pre-established broadcast TWT-SP between the first access point and the second access point.

20. The first access point according to claim 10, wherein the enhanced TWT request includes an enhanced control field for the negotiation and/or coordination of the at least one pre-established broadcast TWT-SP between the first access point and the second access point.
